(19) United States
(12) Patent Application Publication
(10) Pub. No.: US 2018/0276711 A1
(43) Pub. Date: Sep. 27, 2018

(54) CONTENT DISTRIBUTION SERVER

(71) Applicant: TOSHIBA TEC KABUSHIKI KAISHA, Tokyo (JP)

(72) Inventor: Akiko WATANABE, Sunto Shizuoka (JP)

(21) Appl. No.: 15/918,707

(22) Filed: Mar. 12, 2018

(30) Foreign Application Priority Data
Mar. 22, 2017 (JP) 2017-056634

(51) Int. Cl. G06Q 30/02; H04L 29/08

(52) U.S. Cl. CPC G06Q 30/0255; H04L 67/10; G06Q 30/0226

(57) ABSTRACT

A content distribution server includes a storage device that stores a member management table that includes, in correspondence with each of a plurality of member codes, a transmission address, and attribute data of a member. A content distribution management table includes for each of a plurality of content distribution codes, content subject items, a normal distribution date, and a preferential distribution date. A processor determines whether to transmit a content message including the content subject items to the transmission address on the preferential distribution date based on the content subject items compared to the attribute data. If the content message is to be transmitted on the preferential distribution data, the content message is transmitted to the transmission address when a current date is the preferential distribution date. Otherwise, the content message is transmitted to the transmission address when the current date is the normal distribution date.

### CROSS-REFERENCE TO RELATED APPLICATION

This application is based upon and claims the benefit of priority from Japanese Patent Application No. 2017-056634, filed Mar. 22, 2017, the entire contents of which are incorporated herein by reference.

### FIELD

Embodiments described herein relate generally to a content distribution server.

### BACKGROUND

In the retail industry where a competitive edge is important, a point system or an advertisement mail distribution system is introduced in order to keep regular customers and increase the number of customers visiting a store. The point system is useful for keeping customers and increasing customer transactions. The advertisement mail distribution system is useful for urging customers to visit a store or increasing the number and frequency of visits to the store.

Although customers visiting the store do not necessarily purchase commodities, an increase in the number of customers visiting the store directly leads to an increase in the number of purchasers. Accordingly, there is a need for an advertisement distribution apparatus capable of distributing an advertisement that increases the number of customers visiting the store.

The advertisement that intends to increase the number of customers visiting the store should also appeal to the customer's feelings. For example, such an advertisement needs to stimulate self-esteem of the customer. That is, the advertisement should not only inform a customer of sale information, campaign information, or the like but also focus on the customer's feeling.

### DESCRIPTION OF THE DRAWINGS

FIG. 1 is a block diagram illustrating a configuration of an advertisement distribution apparatus according to an embodiment and an advertisement distribution system using the advertisement distribution apparatus.

FIG. 2 is a diagram illustrating information for a single customer in a member management table.

FIG. 3 is a diagram illustrating information for a single advertisement included in an advertisement management table.

FIG. 4 is a flowchart of advertisement distribution processing to be performed by the advertisement distribution apparatus.

### DETAILED DESCRIPTION

Embodiments provide a content distribution server capable of distributing a content message based on a member's attributes.

A content distribution server includes a storage device that stores a member management table that includes, in correspondence with each of a plurality of member codes, a transmission address, and attribute data of a member corresponding to the respective member code. A content distribution management table includes, in correspondence with each of a plurality of content distribution codes, a list of one or more content subject items, a normal distribution date, and a preferential distribution date earlier than the normal distribution data. A processor, for each member code with respect to each content distribution code, determines whether to transmit a content message including the content subject items to the transmission address on the preferential distribution date based on the list of content subject items compared to the attribute data. If the content message is determined to be transmitted on the preferential distribution data, the content message is transmitted to the transmission address when a current date is the preferential distribution date. If the content message is not determined to be transmitted on the preferential distribution data, the content message is transmitted to the transmission address when the current date is the normal distribution date.

In the following, an example of an embodiment will be described with reference to the drawings. In the present embodiment, an example of providing an advertisement distribution service as an additional service to a member of a point service will be described.

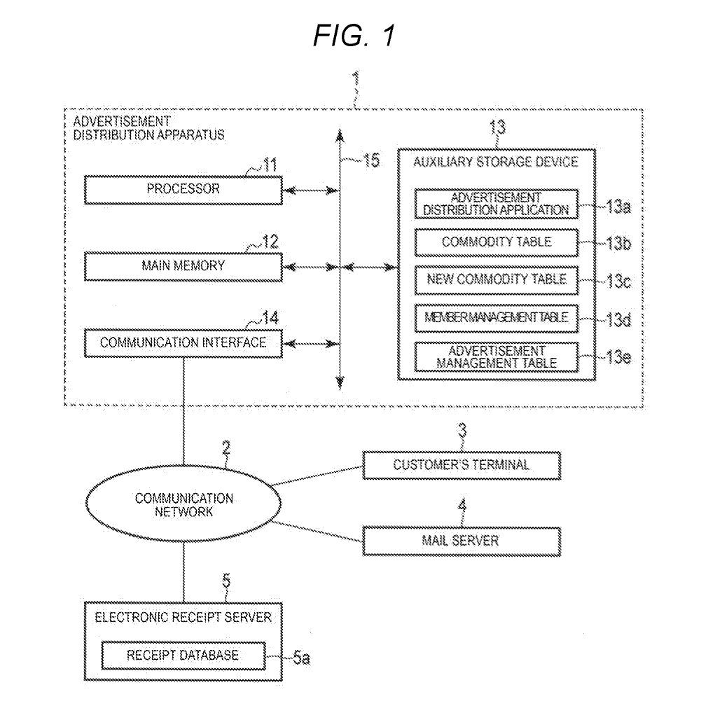

FIG. 1 is a block diagram illustrating a configuration of an advertisement distribution apparatus according to the present embodiment and a configuration of an advertisement distribution system using the advertisement distribution apparatus.

An advertisement distribution apparatus 1 provides an advertisement distribution service for distributing advertisement data for enabling a customer registered as a member of a point service to view an advertisement on a customer's terminal 3. The terminal 3 is an information terminal possessed by the customer. In the present embodiment, an e-mail is used for sending advertisement data. That is, the advertisement distribution apparatus 1 designates a mail address pre-registered for each customer as a destination and transmits an e-mail including advertisement data (hereinafter, referred to as “advertisement e-mail”) to the customer's terminal 3 through a communication network 2 and a mail server 4. The advertisement data may be data representing contents of the advertisement or data such as a uniform resource locator (URL) for accessing the contents of the advertisement through the communication network 2. The advertisement data maybe included in the body of the e-mail or may be included in an attached file. The advertisement distribution apparatus 1 may refer to a receipt database 5a stored by an electronic receipt server 5 in order to distribute the advertisement data.

The advertisement distribution apparatus 1 includes a processor 11, a main memory 12, an auxiliary storage device 13, a communication interface 14, and a bus 15 which is a transmission path. For hardware of the advertisement distribution apparatus 1, for example, a general-purpose information processing apparatus such as a computer can be used.

In the advertisement distribution apparatus 1, the processor 11, the main memory 12, and the auxiliary storage device 13 are connected through the bus 15 to thereby control the advertisement distribution apparatus 1.

The processor 11 corresponds to a central processor of the computer. The processor 11 controls the respective components to realize various functions as the advertisement distribution apparatus 1 according to an operating system or an application program.

The main memory 12 corresponds to a main memory of the computer. The main memory 12 includes a nonvolatile memory area and a volatile memory area. The main memory 12 stores the operating system or the application program in the nonvolatile memory area. The main memory 12 may store data necessary for the processor 11 to execute various types of information processing in the nonvolatile or the volatile memory area. The main memory 12 uses the volatile memory area as a work area where data is appropriately rewritten by the processor 11.

The auxiliary storage device 13 corresponds to an auxiliary storage of the computer. The auxiliary storage device 13 is, for example, an electric erasable programmable read-only memory (EEPROM), a hard disc drive (HDD), a solid state drive (SSD), or the like. The auxiliary storage device 13 stores data used for the processor 11 to perform various information processing and data generated by the processor 11. The auxiliary storage device 13 may store the application program described above.

The communication interface 14 is an interface for data communication through the communication network 2.

The bus 15 includes an address bus, a data bus, and the like, and transmits data and signals between each connected unit described above.

One of the application programs stored in the auxiliary storage device 13 is an advertisement distribution application 13a which is a program for advertisement distribution processing to be described below. A portion of a storage area of the auxiliary storage device 13 is used to store a commodity table 13b, a new commodity table 13c, a member management table 13d, and an advertisement management table 13e.

The commodity table 13b includes various information about each of the commodities which can become an advertisement target. The information included in the commodity table 13b is, for example, a commodity code, a category code, a manufacturer code, and the like. The commodity code is a unique code for identifying the commodity. The category code is a code unique to a commodity category to which the commodity belongs. The manufacturer code is a code for identifying a manufacturer that manufactures the commodity. The commodity table may include a commodity name, a unit price, a commodity sales date, an advertisement transmission flag, and the like.

The new commodity table 13c includes various information about new commodities which are newly released in a recent, predetermined period. The information included in the new commodity table 13c may include, for example, the commodity code, the category code, a release date, and the like. The new commodity table 13c may include the commodity name, a manufacturer unit price, commodity description, an image link, an advertisement transmission desired flag, a commodity sales date, and the like.

The member management table 13d includes various information about customers who are registered members.

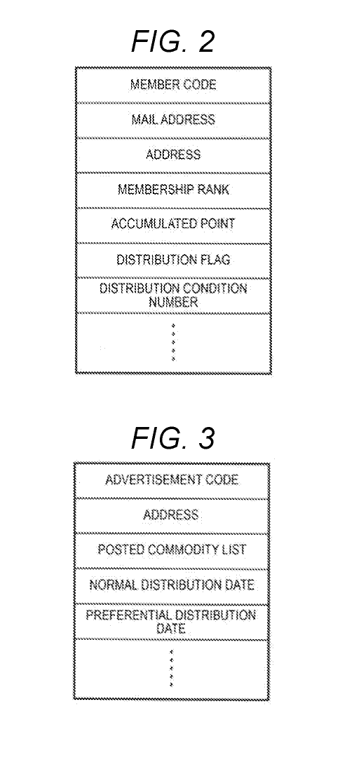

FIG. 2 is a diagram illustrating information included for a single customer in the member management table 13d.

As illustrated in FIG. 2, the member management table 13d includes an e-mail address, a street address, a membership rank, an accumulated point, a distribution flag, a distribution condition number, and the like in association with the member code. In addition to the information illustrated in FIG. 2, the member management table 13d may include information such as a member name, a member registration date, a message transmission flag, a message transmission date and time, or an advertisement transmission completion date and time.

The customer code is a code for identifying each customer who is a registered member.

The e-mail address is set in advance as a transmission destination of the advertisement e-mail.

The physical address indicates a location of a customer's place of residence. The physical address may be a mailing address of the residence or may be the longitude and latitude of the residence.

The membership rank is a numerical value indicating a rank which is set for use of the point service for the customer. For example, it is assumed that as the customer becomes a more frequent shopper at a store, a larger value is set for the membership rank. However, the quality level of the customer may be arbitrarily determined by the store or the like. As an example, it is assumed that the larger the total purchase amount by the customer in a certain period in the store, or the larger the accumulated point number for the customer, a larger membership rank is set.

If the customer desires to receive distribution of the advertisement, the distribution flag is set.

A distribution condition number is a number which is set for identifying each of the plurality of conditions relating to distribution of the advertisement. In the present embodiment, as the distribution condition number, when distribution of the advertisement under the corresponding distribution condition is considered more likely to lead to a purchase behavior of the customer, a larger value is set. However, the distribution condition and the distribution condition number may be arbitrarily determined by a service provider. In the member management table 13d, the distribution condition number of the distribution condition selected by the customer is stored.

Information is written to the member management table 13d by the processor 11 in response to an instruction from the customer at the time of member registration, for example. The information included in the member management table 13d may be rewritten by the processor 11 in response to a change instruction from the customer.

The advertisement management table 13e includes various pieces of information about the advertisement which becomes a distribution target.

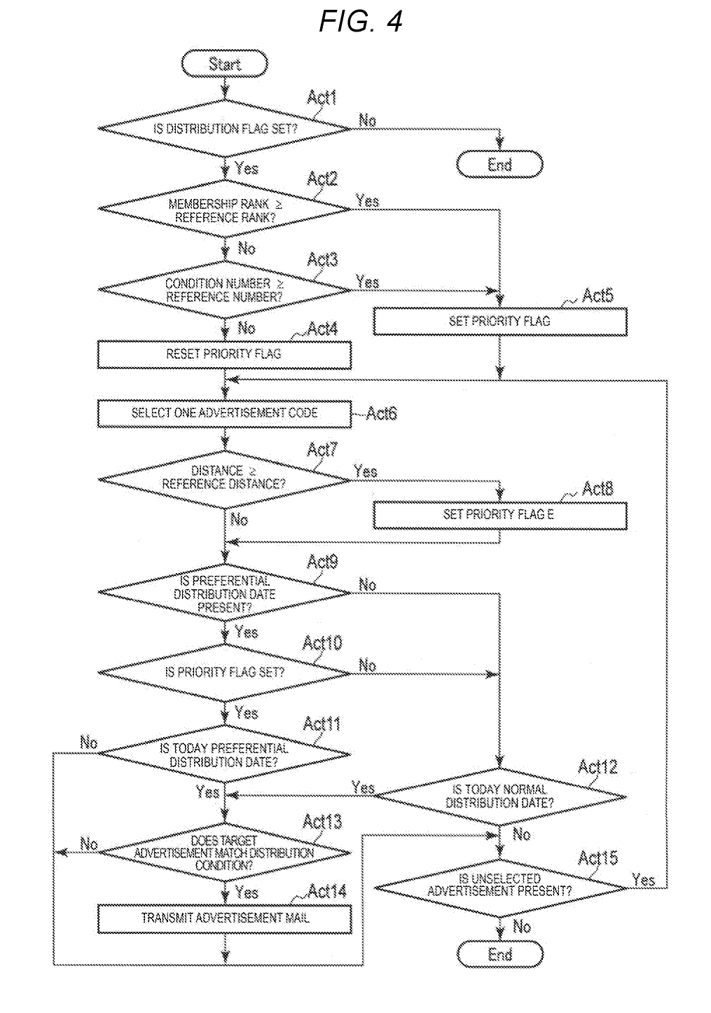

FIG. 3 is a diagram illustrating information for a single advertisement included in the advertisement management table 13e.

As illustrated in FIG. 3, the advertisement management table 13e includes a store address, a posted commodity list, a normal distribution date, a preferential distribution date, and the like in association with the advertisement code. In addition to the information illustrated in FIG. 3, the advertisement management table 13e may include information such as an advertisement publication date, for example.

The store address in the advertisement management table 13e is a physical address indicating a location of a store or the like which becomes an advertisement target. If a plurality of stores or the like which become the advertisement target exist, each physical address of the plurality of stores is included. That is, for example, for the advertisement code of the advertisement related to a special sale to be commonly conducted at chain stores, each physical address of the plurality of stores in which the special sale is conducted are stored in association. If a specific store is not targeted for the advertisement, the physical address is not included in the advertisement management table 13e, or, alternatively, included in the advertisement management table 13e with a predetermined invalid value. That is, for example, for an advertisement code of an advertisement related to a new commodity to be sold at an unspecific store, the physical address is not included or an invalid value is associated. The address may be a street address or may be the longitude and latitude of the physical location of the store, but it is preferable that the physical address is the same type as the physical address included in the member management table 13d.

The advertisement code is a code for identifying each advertisement.

The posted commodity list is a list of commodity codes corresponding to commodities to be posted in the advertisement. There may be only one commodity listed in the list.

Both the normal distribution date and the preferential distribution date are information indicating timing to distribute an advertisement. The normal distribution date is a date on which a normal distribution of advertisement is performed. The preferential distribution date is a date on which preferential distribution of advertisement (hereinafter, referred to as preferential distribution) is performed. As the preferential distribution date, a date before the normal distribution date is set in principle. The preferential distribution date may not be set. If the preferential distribution date is not set, the advertisement management table may not include information as the preferential distribution date, or a predetermined invalid value may be included as information of the preferential distribution date.

Next, description will be made on the operation of the advertisement distribution apparatus 1 configured as described above. When the advertisement distribution apparatus 1 is in a normal operation state, the processor 11 executes information processing once for each of a plurality of customers, based on the advertisement distribution application 13a, which targets a single person out of the customers who are registered as members, within a predetermined period. In this embodiment, it is assumed that a date in units of days is set as the normal distribution date and the preferential distribution date, and the advertisement to be distributed is distributed once at the distribution dates.

FIG. 4 is a flowchart of advertisement distribution processing to be performed by the processor 11 of FIG. 1 based on an advertisement distribution application 13a. The contents of the advertisement distribution processing to be described below are merely examples, and various processing capable of obtaining similar results can be appropriately used.

As Act 1, the processor 11 confirms whether a distribution flag stored in the member management table 13d in association with a member code of a target customer is a set state or not. If the target customer does not desire to receive distribution of the advertisement, the distribution flag illustrated in the member management table 13d in association with the member code of the customer is in a reset state. Accordingly, when the corresponding distribution flag is in reset state, the processor 11 determines that the confirmation result is “No” and ends information processing illustrated in FIG. 4 without performing the advertisement distribution processing. In contrast, when the target customer desires to receive the distribution of the advertisement, the distribution flag illustrated in the member management table 13d in association with the member code of the customer is in the set state. Accordingly, when the corresponding distribution flag is in the set state, the processor 11 determines that the confirmation result is “Yes” and proceeds to Act 2.

As Act 2, the processor 11 confirms whether a membership rank of the target customer is equal to or greater than a predetermined reference rank or not. The reference rank is a threshold for dividing a customer into two groups according to the membership rank. The reference rank maybe arbitrarily determined by, for example, the service provider. Then, when the membership rank is lower than the reference rank and thus, it is determined that the determination result is “No”, the processor 11 proceeds to Act 3.

As Act 3, the processor 11 confirms whether a distribution condition number of the target customer is equal to or larger than a reference number or not. The reference number is a threshold for dividing the customer into two groups according to the distribution condition. The reference number may be arbitrarily determined by, for example, the service provider. When the distribution condition number is less than the reference number and thus, it is determined that the determination result is “No”, the processor 11 proceeds to Act 4.

As Act 4, the processor 11 sets a priority flag to the reset state. The priority flag is a flag for temporarily managing whether the target customer is a target of the preferential distribution at the present time or not. The reset state indicates that the customer is not a target of the preferential distribution.

On the other hand, if the membership rank is equal to or greater than the reference rank, or if the distribution condition number is equal to or greater than the reference number, the processor 11 determines that the determination result in Act 2 or Act 3 is “Yes” and proceeds to Act 5.

As Act 5, the processor 11 sets the priority flag to the set state. That is, if the target customer has a membership rank equal to or greater than the reference rank, or if the distribution condition number of the target customer indicates that the advertisement would increase the purchase behavior of the customer to a certain extent, the priority flag is set to the set state.

After the priority flag is set in Act 4 or Act 5, the processor 11 proceeds to Act 6.

As Act 6, the processor 11 selects one of the advertisement codes included in the advertisement management table 13e. In the following description, an advertisement identified by the advertisement code selected here is referred to as a target advertisement.

As Act 7, the processor 11 confirms whether a distance between a physical address of the store and a customer's physical address is equal to or greater than a predetermined reference distance or not. The physical address of the store here is the physical address indicated in the advertisement management table 13e in association with the advertisement code of the target advertisement. The customer's physical address is the physical address indicated in the member management table 13d concerning the target customer. When a plurality of physical addresses of the stores are illustrated in the advertisement management table 13e in association with the advertisement code of the target advertisement, the processor 11 calculates each distance between physical addresses of stores and the customer's physical addresses. The processor 11 compares the shortest distance among the calculated distances with the reference distance. The member management table 13d may include information about stores that the customers frequently utilize. When one of the plurality of physical addresses of the stores is an address of the store that the target customer frequently utilizes, the processor 11 may compare the distance between the physical address of the store and the customer's physical address with the reference distance. When the distance between the physical address of the store and the customer's physical address is equal to or greater than the reference distance, the processor 11 determines that the confirmation result is “Yes” and proceeds to Act 8.

As Act 8, the processor 11 sets the priority flag to the set state. That is, if the target store of the advertisement exists and the distance to the store from the customer's residence is greater than a certain reference distance, the processor 11 sets the priority flag to the set state. If the priority flag is already set to the set state in Act 5, the processor 11 may omit Act 7 and Act 8.

When Act 8 is ended, the process proceeds to Act 9 by the processor 11. The distance between the physical address of the store and the customer's physical address is less than the reference distance and thus, when it is determined that the confirmation result in Act 7 is “No”, the processor 11 passes Act 8 and proceeds to Act 9.

As Act 9, the processor 11 confirms whether the preferential distribution date is set for the target advertisement or not. Then, when information indicating a valid preferential distribution date is included in the advertisement management table 13e in association with the advertisement code of the target advertisement, the processor 11 determines that the confirmation result is “Yes” and the process proceeds to Act 10.

As Act 10, the processor 11 confirms whether the priority flag is the set state or not. Then, when the priority flag is the set state, the processor 11 determines that the determination result is “Yes” and proceeds to Act 11.

As Act 11, the processor 11 confirms whether the current date is the preferential distribution date or not.

On the other hand, when the information indicating an effective preferential distribution date is not included in the advertisement management table 13e in association with the advertisement code of the target advertisement, the processor 11 determines that the result in Act 9 is “No”. When the priority flag is in the reset state, the processor 11 determines that the confirmation result in Act 10 is “No”. Then, the processor 11 proceeds to Act 12 in either case.

As Act 12, the processor 11 confirms whether the current date is the normal distribution date which is set for the target advertisement or not.

If the current date is the preferential distribution date or the normal distribution date, the processor 11 determines that the confirmation result in Act 11 or Act 12 is “Yes” and the processor 11 proceeds to Act 13 in either case.

As Act 13, the processor 11 confirms whether the target advertisement matches the distribution condition which is set by the target customer or not. Specifically, the processor 11 confirms whether or not the target advertisement matches the distribution condition which corresponds to the distribution condition number included in the member management table 13d in association with the customer code of the target customer.

For example, the distribution conditions are the following five conditions:

Distribution condition number “5”: The same commodity as the commodity purchased by the target customer in the past is included in the posted commodities.

Distribution condition number “4”: A new commodity which has the manufacturer and category which are the same as that of the commodity purchased by the target customer in the past, respectively, is included in the posted commodities.

Distribution condition number “3”: An arbitrary commodity which has the manufacturer and category which are the same as that of the commodity purchased by the target customer in the past, respectively, is included in the posted commodities.

Distribution condition number “2”: A new commodity which has an arbitrary manufacturer and for which the category is the same as that of the commodity purchased by the target customer in the past is included in the posted commodities.

Distribution condition number “1”: An arbitrary commodity which has an arbitrary manufacturer and for which the category is the same as that of the commodity purchased by the target customer in the past is included in the posted commodities.

The processor 11 accesses an electronic receipt server 5 in order to determine whether the distribution conditions are met. The electronic receipt server 5 provides an electronic receipt service to a member of the point service. That is, information about commodities purchased in the past by the members of the point service is recorded in the receipt database 5a. The processor 11 assumes the commodity recorded in the receipt database 5a in association with the target customer is a commodity purchased by the target customer in the past. In addition, the processor 11 determines whether each manufacturer of the posted commodity, the commodity purchased by the target customer in the past, and the new commodity are the same or not, by comparing the manufacturer codes included in the commodity table 13b in association with the commodity codes of each commodity. Further, the processor 11 determines whether each category of the posted commodity, the commodity purchased by the target customer in the past, and the new commodity are the same or not, by comparing category codes included in the commodity table 13b and the new commodity table 13c in association with the commodity codes of each commodity.

When the target advertisement matches the distribution condition which is set by the target customer, the processor 11 determines that the confirmation result in Act 13 is “Yes” and proceeds to Act 14.

As Act 14, the processor 11 transmits the advertisement e-mail to a mail server 4 from the communication interface 14 by using an e-mail address, which is included in the member management table 13d in association with the customer code of the target customer, as the destination. The processor 11 acquires advertisement data associated with the advertisement code of the target advertisement, and includes the advertisement data in the body of the advertisement mail or attaches the advertisement data to the body. The advertisement data may be saved in an auxiliary storage device 13 or may be saved in any external storage device such as a storage device included in an arbitrary server device accessible from the advertisement distribution apparatus 1 through the communication network 2. The advertisement e-mail is transmitted by the mail server 4 to the customer's terminal 3 with which the e-mail address is associated. Otherwise, the advertisement e-mail is retrieved from the mail server 4 to the customer's terminal 3, by allowing the customer's terminal 3 to access the mail server 4. Accordingly, when the advertisement data included in the body of the advertisement e-mail or attached to the body directly represents the contents of the advertisement, the target customer is able to confirm the contents of the advertisement displayed by an e-mail client or a browser provided in the customer's terminal 3. In addition, when the advertisement data indicates the URL, the target customer is able to confirm the contents of the displayed advertisement by accessing the URL by using the browser of the customer's terminal 3.

Here, the membership rank, a setting situation of the distribution condition, or the distance between the physical address of the store and the customer's physical address may each be regarded as attribute data of the customers. The fact that the processor 11 sets the priority flag to the set state or the reset state in Act 4, Act 5, and Act 8 based on the determination results in Act 2, Act 3, and Act 7 corresponds to determining the distribution timing. Thus, the processor 11 executes information processing based on the advertisement distribution application 13a, so that the computer having the processor 11 as the central processor functions as a determination unit for determining the distribution timing based on the attribute data of the customer. The computer having the processor 11 as the central processor functions as a distribution unit for distributing the advertisement data at the determined distribution timing.

When transmitting of the advertisement e-mail is ended, the processor 11 proceeds to Act 15. If the current date is not the preferential distribution date—that is, it is determined that the confirmation result in Act 11 is “No” or if the target advertisement does not match the distribution condition and thus, it is determined that the confirmation result in Act 13 is “No” —the processor 11 passes Act 14 and proceeds to Act 15. When the current date is not a normal distribution date and thus, it is determined that the confirmation result in Act 12 is “No”, the processor 11 passes Act 13 and Act 14 and proceeds to Act 15.

As Act 15, the processor 11 confirms whether there is any advertisement code, which is not yet selected, among the advertisement codes included in the advertisement management table 13e or not. When it is determined that there is the advertisement code which is not yet selected, the processor 11 determines that the determination result is “Yes” and repeats processing starting Act 6 in the same manner as described above. However, if Act 6 is executed for the second time or later, the processor 11 selects an advertisement code that has not been selected in Act 6 so far. With this, the processor 11 sequentially executes processing of Act 6 to Act 14 by sequentially regarding each of the advertisements managed by the advertisement management table 13e as a target advertisement. When processing of Act 6 to Act 14 is ended after regarding each advertisement managed by the advertisement management table 13e as the target advertisement, the processor 11 determines that the determination result in Act 15 is “No”. Accordingly, in this case, the processor 11 ends information processing illustrated in FIG. 4.

As described above, according to the advertisement distribution apparatus 1, advertisements are preferentially distributed to only some of the customers in preference to other customers. Accordingly, a customer who preferentially receives distribution of advertisements can plan the purchase of commodities or the like with consideration of the early advertisement. That is, it is possible to distribute the sophisticated advertisement based on personal characteristics of customers. Distribution of an advertisement at the preferential distribution date is a special service for customers who receive the advertisement and can give superior benefits to the corresponding customer.

When it is intended to distribute the advertisement to all customers who are members at the preferential distribution date, there is a concern that loss of the advertisement benefit due to some members refraining from buying commodities may become too large. In contrast, according to the advertisement distribution apparatus 1, the advertisement benefit can be efficiently obtained while the loss of the advertiser's side is suppressed.

According to the advertisement distribution apparatus 1, a customer whose membership rank related to the point service is equal to or greater than the reference rank is set as a target of preferential distribution. Accordingly, the preferential distribution can be performed as a special service to a member of the point service who frequently earns points. By changing a value of the reference rank, it is possible to change a ratio between the customers who are a target of the preferential distribution and the customers who are not the target. It is convenient to arbitrarily change the reference rank. Also, it may be possible to set the reference rank for each advertisement.

According to the advertisement distribution apparatus 1, it is determined, according to a distribution condition of an advertisement designated by the customer, whether the preferential distribution is to be performed or not. Accordingly, it is possible to effectively distribute advertisements to customers which are highly likely to purchase of commodities targeted for advertisement by advertisement. For example, when the customer requests advertisement information about the same commodity as the commodity purchased by the customer in the past, it maybe regarded that the customer is highly likely to purchase the corresponding commodity if the corresponding commodity becomes the commodity targeted for the advertisement. Accordingly, it is possible to improve the advertisement effect by preferentially distributing the advertisement to such customers. By changing matters on which the distribution condition is to be targeted for preferential distribution, it is possible to change a ratio between the customers who are the target of the preferential distribution and the customers who are not the target of the preferential distribution. Accordingly, it is convenient when the distribution condition to be targeted for preferential distribution can be arbitrarily set. Also, such setting may be made for each advertisement.

According to the advertisement distribution apparatus 1, a customer for which the distance from a store targeted for advertisement to the place of residence of the customer is equal to or greater than the reference distance is set as a target of preferential distribution. Accordingly, it is possible to give a sufficient consideration period to such a customer and to increase the possibility that the customer visits the store targeted for advertisement by ignoring inconvenience due to distance. Determination of such distribution target is particularly effective for distribution of the advertisement related to a time service. Customers who live far away to the store targeted for the advertisement are required to depart from their residence earlier than customers who live closer in order to visit the store during a time service period. By changing the value of the reference distance, it is possible to change the ratio between the customers who are the target of the preferential distribution and the customers who are not the target of the preferential distribution. Accordingly, it is convenient to arbitrarily set the reference distance. It may be possible to set the reference distance for each advertisement.

According to the advertisement distribution apparatus 1, the same advertisement is distributed to the customers targeted for the preferential distribution at both the preferential distribution date and the normal distribution date. For that reason, if the customer forgets the contents of the advertisement distributed at the preferential distribution date, the customer becomes able to remember from the distribution performed at the normal distribution date again.

For the present embodiment, the following various modification examples can be made.

A portion of the information processing described above to be performed by the processor 11 maybe omitted. For example, the processor 11 may not perform one or two of Act 2, Act 3, and Act 7. If the processor 11 does not perform Act 7, the processor 11 also does not perform Act 8 and proceeds from Act 6 to Act 9.

The advertisement distributed to a certain customer at the preferential distribution date may not be distributed to the same customer at the normal distribution date. By doing as such, the same advertisement is not distributed to the same customer many times and the customer does not feel annoyed. Whether the customer desires to receive distribution of the same advertisement at both the preferential distribution date and the normal distribution date or not may vary for each customer. Accordingly, whether to distribute the same advertisement at both of the preferential distribution date and the normal distribution date or not may be set for each customer by the advertisement distribution apparatus 1.

The distribution dates maybe set to three or more levels. In this case, information about three or more distribution dates is included in the advertisement management table 13e instead of the normal distribution date and preferential distribution date. The processor 11 selects one of the distribution dates out of three or more levels by comparing at least one of the determinations in Act 2, Act 3, and Act 7 by using a plurality of reference values. Otherwise, the processor 11 may select one of distribution dates out of three or more levels according to the determination results in Act 2, Act 3 and Act 7. As an example, if the determination result in Act 2 is “Yes”, the earliest distribution date may be selected, if the determination results in Act 3 and Act 7 are “Yes”, the second earliest distribution date may be selected, and if the determination results in Act 2, Act 3, and Act 7 are “No”, the latest distribution date may be selected, respectively.

The processor 11 may add the target advertisement to a list of distribution candidate advertisements as Act 14, may determine that the determination result in Act 15 is “No”, and then may transmit the advertisement included in the list of distribution candidate advertisements by one e-mail. In this case, if a large number of advertisements are included in the list of distribution candidate advertisements, the processor 11 may divide the advertisements into a plurality of groups and transmit the e-mail for each group.

The advertisement mail transmitted from the communication interface 14 to the mail server 4 by regarding the e-mail address included in the member management table 13d in association with the customer code of the target customer as a destination. The processor 11 acquires the advertisement data associated with the advertisement code of the target advertisement, and includes the advertisement data in the body of the advertisement e-mail or attaches the advertisement data to the body. The advertisement data maybe saved in the auxiliary storage device 13 or may be stored in an external arbitrary storage device such as a storage device included in an arbitrary server device accessible from the advertisement distribution apparatus 1 through the communication network 2.

The member management table 13d may not be stored in the auxiliary storage device 13, but may refer to the same type of table stored in an arbitrary storage device under the management of another device that provides the point service.

A customer who is a member of a service other than the point service may be targeted for the advertisement distribution. The customer may be registered as a member of the advertisement distribution service by the advertisement distribution device 1. That is, the advertisement distribution service is not necessarily provided to the customer together with either one of the point service and the electronic receipt service or both services, but may be provided to the customer as a single service.

If the advertisement distribution service is provided to a customer who is a member of a point service without providing the electronic receipt service, for information about commodities purchased by the customer in the past, a purchase history of a member of the point service can be appropriated. Information about the commodities purchased by the customer in the past may not necessarily be recorded for the electronic receipt service as in the embodiment described above, but may be recorded in a database prepared for the advertisement distribution service.

The function of the advertisement distribution apparatus 1 may be provided in the mail server 4, the electronic receipt server 5, or another web server.

Data representing the purchase history of the customer may be stored in, for example, the auxiliary storage device 13 in the advertisement distribution device 1. The processor 11 may make the determination as Act 13 based on only the data stored in the auxiliary storage device 13, or based on the data and the receipt database 5a.

Hardware of the advertisement distribution apparatus 1 and the application program executed on the hardware may be provided by the same provider to the user of the advertisement distribution apparatus 1 and may be individually assigned to the user by different providers. If the same provider provides the hardware of the advertisement distribution apparatus 1 and the application program to the user of the advertisement distribution apparatus 1, the application program is generally provided in a state of being stored in the main memory 12 or the auxiliary storage device 13 which is the hardware of the advertisement distribution apparatus 1. However, even in such a case, there is no necessity that the application program is in a state of being stored in the main memory 12 or the auxiliary storage device 13 which is the hardware of the advertisement distribution apparatus 1. For example, the application program may be provided in a state of being recorded not in the hardware of the advertisement distribution apparatus 1 but in a removable recording medium such as a magnetic disk, a magneto-optical disk, an optical disk, or a semiconductor memory, or the like, otherwise may be provided by being downloaded from a network resource.

Some or all of the functions to be realized by the processor 11 by information processing can be realized by hardware such as a logic circuit or the like which executes information processing not based on a program. Each of the functions described above can also be realized by combining software control with hardware such as logic circuit described above.

While certain embodiments have been described, these embodiments have been presented by way of example only, and are not intended to limit the scope of the inventions. Indeed, the novel methods and systems described herein maybe embodied in a variety of other forms; furthermore, various omissions, substitutions and changes in the form of the methods and systems described herein maybe made without departing from the spirit of the inventions. The accompanying claims and their equivalents are intended to cover such forms or modifications as would fall within the scope and spirit of the inventions.

What is claimed is:

1. A content distribution server comprising:
a storage device that stores:
a member management table that includes, in correspondence with each of a plurality of member codes, a transmission address, and attribute data of a member corresponding to the respective member code, and
a content distribution management table that includes, in correspondence with each of a plurality of content distribution codes, a list of one or more content subject items, a normal distribution date, and a preferential distribution date earlier than the normal distribution date; and
a processor configured to, for each member code with respect to each content distribution code:
determine whether to transmit a content message including the content subject items to the transmission address on the preferential distribution date based on the list of content subject items compared to the attribute data,
if the content message is determined to be transmitted on the preferential distribution data, transmit the content message to the transmission address when a current date is the preferential distribution date, and
if the content message is not determined to be transmitted on the preferential distribution data, transmit the content message to the transmission address when the current date is the normal distribution date.

2. The server according to claim 1, wherein:
the attribute data includes a membership rank,
the content distribution management table further includes, in correspondence with each of the plurality of content distribution codes, a reference rank, and
the processor determines to transmit the content message on the preferential distribution date if the membership rank is more than the reference rank.

3. The server according to claim 1, wherein the reference rank can be changed by a manager to adjust a ratio of members that receive the content message on the preferential distribution date compared to members that receive the content message on the normal distribution date.

4. The server according to claim 1, wherein the content subject items each correspond to a commodity and a discount offer for the commodity.

5. The server according to claim 4, wherein the processor is further configured to:
acquire a commodity purchase history corresponding to the member code based on the attribute data, and
determine to transmit the content message on the preferential distribution date further based on comparing the acquired commodity purchase history and the commodities that correspond to the content subject items.

6. The server according to claim 4, wherein:
the attribute data includes a physical address of the member,
the content distribution management table further includes, in correspondence with each of the plurality of content distribution codes, a physical address of a store that offers the discount for the commodity, and
the processor determines to transmit the content message on the preferential distribution date if a distance between the physical address of the member and the physical address of the store is greater than a predetermined value.

7. The server according to claim 6, wherein the predetermined value can be changed by a manager to adjust a ratio of members that receive the content message on the preferential distribution date compared to members that receive the content message on the normal distribution date.

8. The server according to claim 4, wherein the content message is an e-mail that includes a URL that allows a user terminal to access the discount offer for the commodity.

9. The server according to claim 4, wherein the content message is an e-mail that includes the discount offer for the commodity in the body of the email.

10. The server according to claim 1, wherein the transmission address is an e-mail address.

11. A content distribution method comprising:
storing a member management table that includes, in correspondence with each of a plurality of member codes, a transmission address, and attribute data of a member corresponding to the respective member code;
storing a content distribution management table that includes, in correspondence with each of a plurality of content distribution codes, a list of one or more content subject items, a normal distribution date, and a preferential distribution date earlier than the normal distribution date; and
for each member code with respect to each content distribution code:
determining whether to transmit a content message including the content subject items to the transmission address on the preferential distribution date based on the list of content subject items compared to the attribute data,
if the content message is determined to be transmitted on the preferential distribution data, transmitting the content message to the transmission address when a current date is the preferential distribution date, and
if the content message is not determined to be transmitted on the preferential distribution data, transmitting the content message to the transmission address when the current date is the normal distribution date.

12. The method according to claim 11, wherein:
the attribute data includes a membership rank,
the content distribution management table further includes, in correspondence with each of the plurality of content distribution codes, a reference rank, and
the content message is transmitted on the preferential distribution date if the membership rank is more than the reference rank.

13. The method according to claim 11, wherein the reference rank can be changed by a manager to adjust a ratio of members that receive the content message on the preferential distribution date compared to members that receive the content message on the normal distribution date.

14. The method according to claim 11, wherein the content subject items each correspond to a commodity and a discount offer for the commodity.

15. The method according to claim 14, further comprising:
acquiring a commodity purchase history corresponding to the member code based on the attribute data; wherein
determining whether to transmit the content message on the preferential distribution date is further based on comparing the acquired commodity purchase history and the commodities that correspond to the content subject items.

16. The method according to claim 14, wherein:
the attribute data includes a physical address of the member,
the content distribution management table further includes, in correspondence with each of the plurality of content distribution codes, a physical address of a store that offers the discount for the commodity, and
the content message is distributed on the preferential distribution date if a distance between the physical address of the member and the physical address of the store is greater than a predetermined value.

17. The method according to claim 16, wherein the predetermined value can be changed by a manager to adjust a ratio of members that receive the content message on the preferential distribution date compared to members that receive the content message on the normal distribution date.

18. The method according to claim 14, wherein the content message is an e-mail that includes a URL that allows a user terminal to access the discount offer for the commodity.

19. The method according to claim 14, wherein the content message is an e-mail that includes the discount offer for the commodity in the body of the email.

20. The method according to claim 11, wherein the transmission address is an e-mail address.
